(19) United States
(12) Patent Application Publication
(10) Pub. No.: US 2020/0200271 A1
(43) Pub. Date: Jun. 25, 2020

(54) COMBINED PISTON STRUCTURE FOR COMPRESSOR

(71) Applicant: Dongguan Hesheng Machinery & Electric Co., Ltd., Dongguan (CN)

(72) Inventor: Fu Li, Dongguan (CN)

(21) Appl. No.: 16/427,364

(22) Filed: May 31, 2019

(30) Foreign Application Priority Data
Dec. 19, 2018 (CN) 201811557331.X

(51) Int. Cl. F16J 9/16; F16J 9/06

(52) U.S. Cl. CPC F16J 9/16; F16J 9/064

(57) ABSTRACT

A combined piston structure for a compressor includes a first piston ring, a second piston ring, an expandable ring, a guide ring, and a piston. A side of the first piston ring has a slit defined as a first cut. An upper end of an outer surface of the first piston ring is provided with an annular protruding portion. A side of the second piston ring has a slit defined as a second cut. A side of the expandable ring has a slit defined as a third cut. The guide ring is annular and made of a self-lubricating material having a low friction coefficient. A side of the guide ring has a V-shaped opening. An upper end of an outer surface of the piston is provided with an annular first groove. An annular second groove is disposed below the first groove.

### BACKGROUND OF THE INVENTION

### 1. Field of the Invention

The present invention relates to a compressor, and more particularly to a combined piston structure for a compressor.

### 2. Description of the Prior Art

Compressors or inflators are mainly used for pneumatic tools, vehicular tires or a variety of devices that require inflation, as a source of air or pressure. As a result, the compressor has become a necessary pneumatic device for workplace or domestic repairs.

The working principle of the compressor is that the compressor is directly driven by the motor, so that the crankshaft of the compressor is rotated at a high speed, and then the link is driven to drive the piston to be reciprocated up and down for changing the volume of the cylinder. Therefore, during the stroke of compression, because the volume of the cylinder is reduced, the compressed air finally enters the air tank via the check valve as kinetic energy for releasing pressurized gas.

The working mode of the cylinders of most small oil-free compressors adopts a swing rubber cup structure for sealing or multiple-channel air ring sealing. However, when the piston ring of the swing rubber cup structure is in operation, it will generate an uneven force, resulting in excessive friction. The piston ring is prone to wear and reduce its service life. Eventually, the compressed air leaks, which affects the working efficiency and the service life of the compressor. Moreover, in a small piston compressor, the stroke motion of the piston is shorter. In the process of the short stroke of compression, a common piston ring cannot be opened in time to be in close contact with the inner wall of the cylinder due to the greater axial thickness and radial thickness of the piston ring. Therefore, the efficiency of the compressor is poor, there are more air leaks, and the pressure cannot be pushed up. If there is only a single piston ring and the axial thickness and radial thickness of the piston ring are reduced, the strength of the piston ring is low, and the rigidity of the piston is poor. The piston ring may be deformed easily at a high temperature, the wear is fast, and the service life of the piston ring is very short. Moreover, the piston ring under high pressure is more likely to be deformed because of its low strength, which further aggravates wear and reduces the service life of the machine greatly.

Accordingly, the inventor of the present invention has devoted himself based on his many years of practical experiences to solve these problems.

### SUMMARY OF THE INVENTION

The primary object of the present invention is to provide a combined piston structure for a compressor, which is simple in structure and reasonable in design to solve the above problems.

In order to achieve the above object, the present invention adopts the following technical solutions.

A combined piston structure for a compressor comprises a first piston ring, a second piston ring, an expandable ring, a guide ring, and a piston. A side of the first piston ring has a slit defined as a first cut. An upper end of an outer surface of the first piston ring is provided with an annular protruding portion. A side of the second piston ring has a slit defined as a second cut. A side of the expandable ring has a slit defined as a third cut. The guide ring is annular and made of a self-lubricating material having a low friction coefficient. A side of the guide ring has a V-shaped opening. An upper end of an outer surface of the piston is provided with an annular first groove. An annular second groove is disposed below the first groove.

By adopting the above technical solutions, the combined piston ring increases the strength of the piston ring when the compressor is working. The combined piston ring won't be deformed and worn easily. The combined piston ring can operate normally under high temperature and high pressure, ensuring the sealing performance of the piston and improving the working efficiency of the compressor.

The beneficial effects of the present invention are described below.

1. According to the present invention, by providing a combined piston ring structure, the pressure gas in the cylinder can be sealed multiple times to avoid air leakage. Besides, the overall sealing performance of the compressor is improved, and the working efficiency of the compressor is further improved.

2. According to the present invention, the rigidity and sealing performance of the piston rings are enhanced by providing piston rings having different axial and radial thicknesses. The piston rings can be opened and closed quickly under high temperature and high pressure to reduce wear and prolong the service life.

3. The present invention has the advantages of simple structure, high stability, reasonable design and easy implementation.

### BRIEF DESCRIPTION OF THE DRAWINGS

FIG. 1 is a perspective view of the present invention;

FIG. 2 is an exploded view of the present invention;

FIG. 3 is a cross-sectional view of the present invention; and

FIG. 4 is an enlarged view of circle A of FIG. 3.

### DETAILED DESCRIPTION OF THE PREFERRED EMBODIMENTS

Embodiments of the present invention will now be described, by way of example only, with reference to the accompanying drawings.

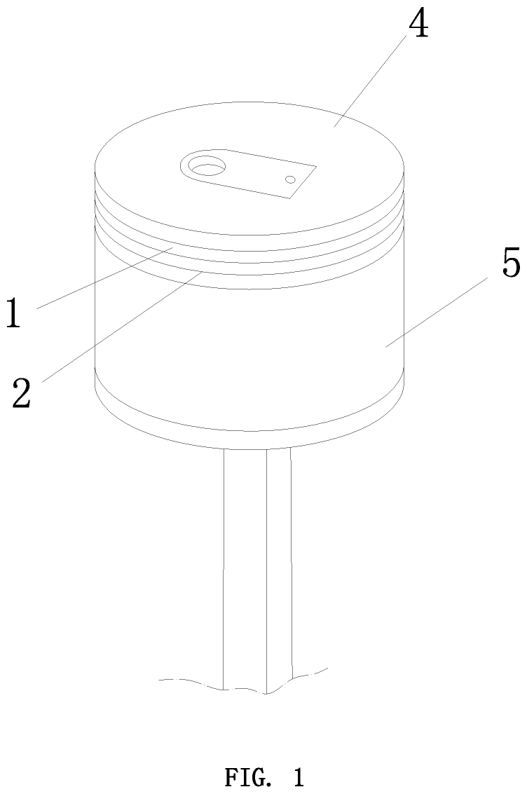

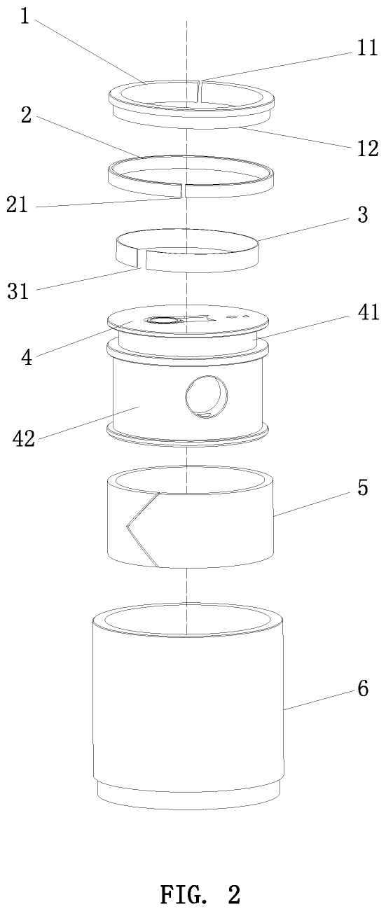

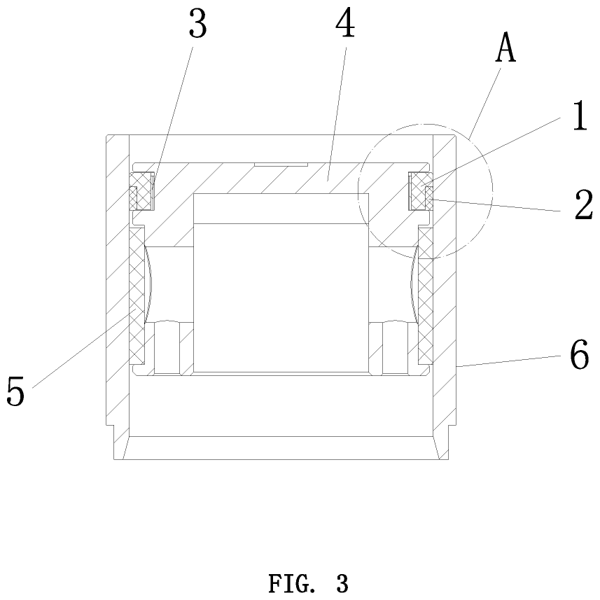

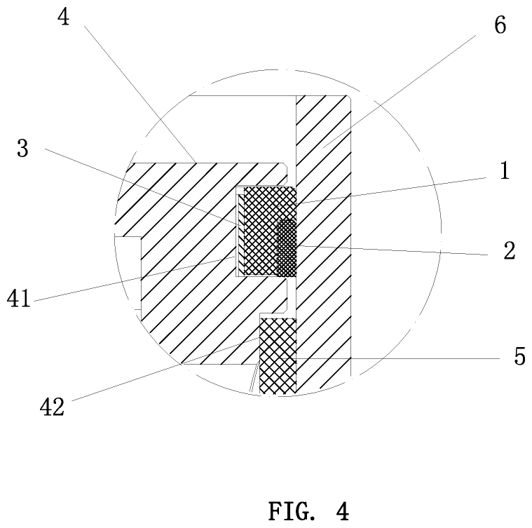

As shown in FIG. 1 through FIG. 6, a combined piston structure for a compressor in accordance with a preferred embodiment of the present invention comprises a first piston ring 1, a second piston ring 2, an expandable ring 3, a guide ring 5, and a piston 4. The first piston ring 1 is annular. A side of the first piston ring 1 has a slit defined as a first cut 11, so that the first piston ring 1 has mechanical properties of elastic expansion under pressure. The upper end of the outer surface of the first piston ring 1 is provided with an annular protruding portion 12, such that the lower half of the first piston ring 1 forms a circumferential recess for supporting and matching the second piston ring 2. The first piston ring 1 is made of a wear-resistant, corrosion-resistant, self-lubricating airtight material, and may be PTFE material. The first piston ring 1 acts as a first seal in the compressor.

The second piston ring 2 is annular. A side of the second piston ring 2 has a slit defined as a second cut 11, so that the second piston ring 2 has mechanical properties of elastic expansion under pressure. The second piston ring 2 is made of a wear-resistant, corrosion-resistant, self-lubricating airtight material, and may be a PTFE material.

The expandable ring 3 is annular and made of thin steel strip with greater elasticity. A side of the expandable ring 3 has a slit defined as a third cut 11, so that the expandable ring 3 has mechanical properties of elastic expansion under pressure.

The guide ring 5 is annular and made of a self-lubricating material having a low friction coefficient. A side of the guide ring 5 has a V-shaped opening, which is simple in processing and easy for installation and disassembly. The guide ring 5 can effectively perform the last throttling sealing of the gas. The guide ring 5 acts as the last throttling sealing for a gas.

An upper end of an outer surface of the piston 4 is provided with an annular first groove 41, and an annular second groove 42 is disposed below the first groove 41. The width of the first groove 41 matches the width of the expandable ring 3. The expandable ring 3 is fitted in a position where the first groove 41 is, and then the first piston ring 1 and the second piston ring 2 are sequentially fitted in the same position. The second piston ring 2 is in close contact with the annular protruding portion 12 of the first piston ring 1 to form a fit. The width of the second groove 42 matches the width of the guide ring 5. The guide ring 5 is fitted onto the second groove 42 for guiding the piston 4 and supporting the connecting rods and the parts of the piston 4 when the piston 4 is reciprocated. The pressure on the piston ring caused by the gravity of the connecting rod and the parts of the piston 4 is reduced, and the friction of the piston ring is further reduced, and the sealing efficiency and the service life of the piston ring are increased.

It should be noted that the expandable ring 3, the first piston ring 1 and the second piston ring 2 are matched with each other in dimension. The radial and axial thicknesses of the first piston ring 1 are greater than the radial and axial thicknesses of the second piston ring 2.

Specifically, the expandable ring 3 is fitted on the surface of the first groove 41 of the piston 4, and then the first piston ring 1 and the second piston ring 2 are sequentially fitted in the same position of the piston 4. The second piston ring 2 is disposed below the annular protruding portion 12 of the first piston ring 1 and is in close contact with the first piston ring 1 to support and cooperate with the first piston ring 1. The guide ring 5 is disposed on the surface of the second groove 42 of the piston 4. The first cut 11 of the first piston ring 1 and the third cut 31 of the expandable ring 3 are staggered. The second cut 21 of the second piston ring 2 and the first cut 11 of the first piston ring 1 are staggered. The expandable ring 3, the first piston ring 1 and the second piston ring 2 are matched with each other in dimension. When the cylinder, the piston 4 and the piston rings are assembled and start working, since the radial and axial thicknesses of the first piston ring 1 is larger, the first ring provides a first sealing function when the compressor is running, and the strength and rigidity is enough to work normally under high temperature and high pressure. During the first sealing of the piston rings at different positions, most of the gas pressure in the piston 4 can be sealed, so that the gas pressure is greatly reduced after the first throttling sealing. The depressurized gas enters the second piston ring 2 again. Under the interaction of the annular protruding portion 12 and the second piston ring 2, the pressure on the second piston ring 2 is reduced. The second piston ring 2 performs a secondary throttling sealing for the internal gas.

During the working process of the compressor, since the axial and radial thicknesses of the second piston ring 2 are less, under the action of the pressure, the second piston ring 2 is opened and closed quickly to avoid gas leakage. In addition, because of the support of the first piston ring 1, the pressure of the incoming gas is less, and the second piston ring 2 with less axial and radial thicknesses does not affect the compression function of the compressor. The service life of the entire compressor will be prolonged.

Furthermore, because the expandable ring 3 is made of thin steel strip with greater elasticity, the entire combined piston structure can be freely attached to the inner wall of the cylinder 6, thereby improving the sealing efficiency and working efficiency of the compressor. During the movement of the piston 4, the expandable ring 3 automatically compensates for the wear of the piston ring under the action of the elastic force, which increases the service life of the piston ring greatly.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A combined piston structure for a compressor, comprising a first piston ring, a second piston ring, an expandable ring, a guide ring and a piston, a side of the first piston ring having a slit defined as a first cut, an upper end of an outer surface of the first piston ring being provided with an annular protruding portion;
a side of the second piston ring having a slit defined as a second cut;
a side of the expandable ring having a slit defined as a third cut;
the guide ring being annular and made of a self-lubricating material having a low friction coefficient, a side of the guide ring having a V-shaped opening;
an upper end of an outer surface of the piston being provided with an annular first groove, an annular second groove being disposed below the first groove.

2. The combined piston structure as claimed in claim 1, wherein the first piston ring and the second piston ring are made of a wear-resistant, corrosion-resistant, self-lubricating airtight material.

3. The combined piston structure as claimed in claim 1, wherein the expandable ring is fitted in a position wherein the first groove is, the first piston ring and the second piston ring are sequentially fitted in the position, and the second piston ring is in close contact with the annular protruding portion of the first piston ring.

4. The combined piston structure as claimed in claim 1, wherein the first groove has a width matching that of the expandable ring, and the second groove has a width matching that of the guide ring.

5. The combined piston structure as claimed in claim 1, wherein the expandable ring, the first piston ring and the second piston ring are matched with each other in dimension, and the first piston ring has radial and axial thicknesses greater than those of the second piston ring.

6. The combined piston structure as claimed in claim 1, wherein the first cut of the first piston ring and the third cut of the expandable ring are staggered, the second cut of the second piston ring and the first cut of the first piston ring are staggered.
